(19) United States
(12) Patent Application Publication
(10) Pub. No.: US 2026/0081491 A1
(43) Pub. Date: Mar. 19, 2026

(54) ROTOR, ELECTRIC ROTARY MACHINE, AND AIRCRAFT

(71) Applicant: KABUSHIKI KAISHA TOSHIBA, Kawasaki-shi Kanagawa (JP)

(72) Inventors: Masaya HAGIWARA, Yokohama Kanagawa (JP); Hirofumi UENO, Ebina Kanagawa (JP); Takashi KUMATA, Kawasaki Kanagawa (JP)

(73) Assignee: KABUSHIKI KAISHA TOSHIBA, Kawasaki-shi Kanagawa (JP)

(21) Appl. No.: 19/302,623

(22) Filed: Aug. 18, 2025

(30) Foreign Application Priority Data
Sep. 17, 2024 (JP) 2024-159949

(51) Int. Cl. H02K 1/278; H02K 1/28

(52) U.S. Cl. CPC H02K 1/278; H02K 1/28

(57) ABSTRACT

A rotor is rotatable about a center axis. A rotary shaft extends in an axial direction of the center axis. A hub member is positioned on a radially outer side of the rotary shaft. A rotor core is positioned on a radially outer side of the hub member. A magnet is disposed on a radially outer circumferential surface of the rotor core. The first fixing member is positioned on one side in the axial direction of the hub member and the rotor core and in contact with the hub member. A second fixing member is positioned on the other side in the axial direction of the hub member and the rotor core and in contact with the hub member. The hub member includes a composite material. The first fixing member and the second fixing member sandwich the rotor core from both sides in the axial direction.

### BACKGROUND OF THE INVENTION

### Field of the Invention

An embodiment of the present invention relates to a rotor, an electric rotary machine, and an aircraft.

### Description of Related Art

Development of an aircraft in which a thrust fan is driven using an electric rotary machine has progressed. An electric rotary machine for an aircraft needs to be lightweight. For the purpose of a decrease in weight, it is conceivable that a part of a rotor or the like be formed of a composite material which is a lightweight material. In this case, there is need for an increase in reliability of a fixing member of a member formed of a composite material and a member formed of a metallic material such as a rotor core.

### Patent Documents

Patent Document 1 Japanese Unexamined Patent Application, First Publication No. 2024-053402

### SUMMARY OF THE INVENTION

An objective of the present invention is to provides a rotor, an electric rotary machine, and an aircraft that can enhance reliability of a fixing member.

A rotor according to an embodiment is able to rotate about a center axis. The rotor includes a rotary shaft, a hub member, a rotor core, a magnet, a first fixing member, and a second fixing member. The rotary shaft extends in an axial direction of the center axis. The hub member is positioned on a radially outer side of the rotary shaft. The rotor core is positioned on a radially outer side of the hub member. The magnet is positioned on a radially outer circumferential surface of the rotor core. The first fixing member is positioned on one side in the axial direction of the hub member and the rotor core. The first fixing member is in contact with the hub member. The second fixing member is positioned on the other side in the axial direction of the hub member and the rotor core. The second fixing member is in contact with the hub member. The hub member includes a composite material. The first fixing member and the second fixing member sandwich the rotor core from both sides in the axial direction.

An electric rotary machine according to another embodiment includes the aforementioned rotor and a stator. The stator is located on a radially outer circumferential side of the rotor.

An aircraft according to another embodiment includes the aforementioned electric rotary machine and a thrust fan. The thrust fan is rotated by the electric rotary machine.

### BRIEF DESCRIPTION OF THE DRAWINGS

FIG. 1 is a sectional view parallel to a center axis of a rotor according to an embodiment.

FIG. 2 is a sectional view perpendicular to a center axis of an electric rotary machine according to the embodiment.

FIG. 3 is a partial sectional view illustrating the vicinity of a first fixing member of the rotor according to the embodiment.

FIG. 4 is a partial sectional view illustrating the vicinity of a second fixing member of the rotor according to the embodiment.

FIG. 5 is a schematic sectional view of a rotor according to a modified example.

FIG. 6 is a diagram schematically illustrating an example of a configuration of an aircraft according to the embodiment.

### DETAILED DESCRIPTION OF THE INVENTION

Hereinafter a rotor, an electric rotary machine, and an aircraft according to an embodiment will be described with reference to the accompanying drawings.

The rotor, the electric rotary machine, and the aircraft can be appropriately changed in design according to specifications or the like. Accordingly, shapes and the like of members included in the rotor, the electric rotary machine, and the aircraft can be arbitrarily modified, and shapes, numbers, and the like in the drawings are only an example.

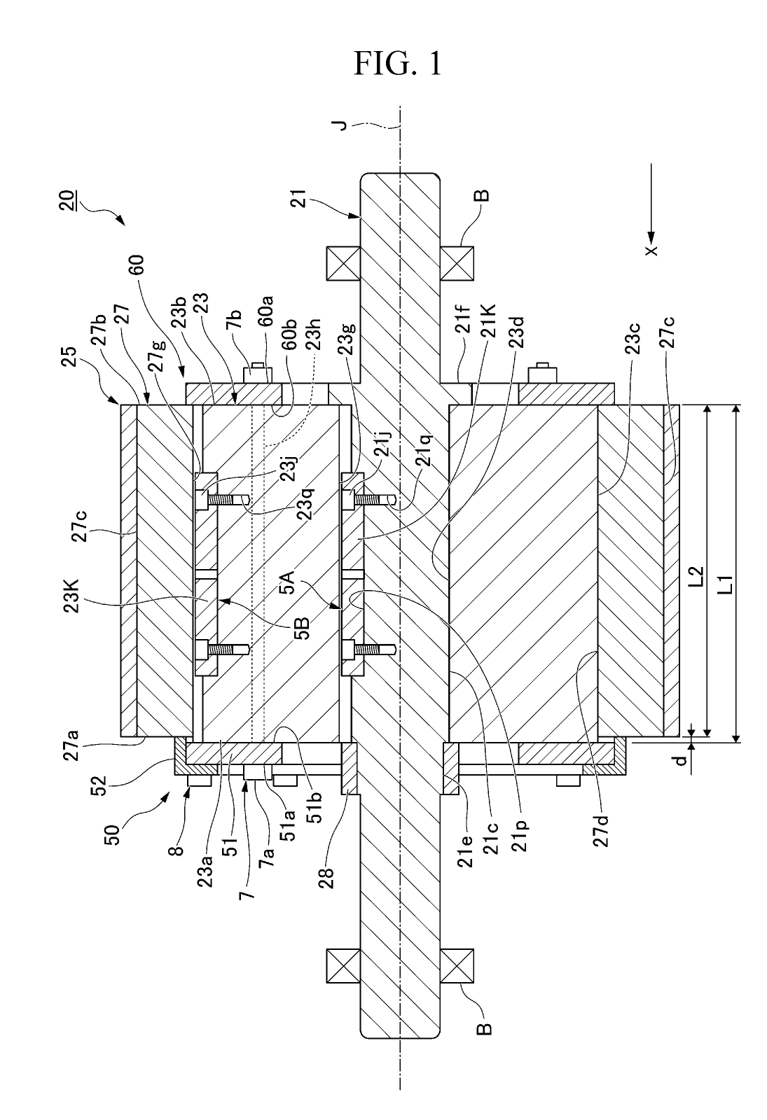

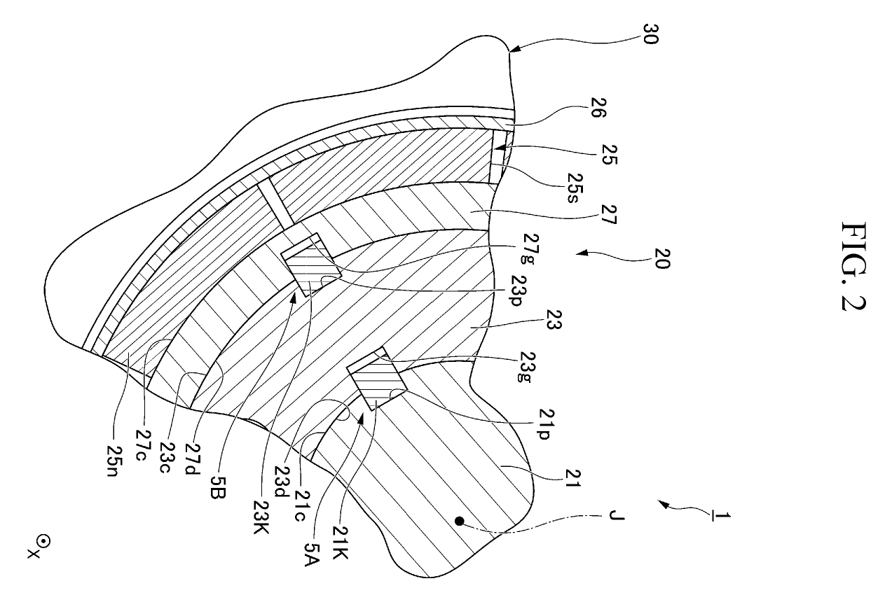

FIG. 1 is a sectional view parallel to a center axis J of a rotor 20 according to the present embodiment. FIG. 2 is a sectional view perpendicular to the center axis J of an electric rotary machine 1 according to the present embodiment.

In the following description, a direction parallel to the center axis J is simply referred to as an “axial direction X,” a radial direction centered on the center axis J is simply referred to as a “radial direction,” and a circumferential direction about the center axis J is simply referred to as a “circumferential direction.” In the drawings, the axial direction X is illustrated according to necessity. In the drawings, a direction indicated by an arrow of the axial direction X is referred to as an “axially one side (+X),” and a reverse direction thereof is referred to as an “axially other side (-X).”

As illustrated in FIG. 1, the rotor 20 includes a rotary shaft 21 including the center axis J, a hub member 23, a rotor core 27, a magnet unit 25, a first fixing member 50, a second fixing member 60, and a connection member 7.

The rotary shaft 21 has, for example, a cylindrical shape extending in the axial direction X of the center axis J. The rotary shaft 21 is supported, for example, by two bearings B. For example, one of the two bearings B supports one end of the rotary shaft 21, and the other supports the other end of the rotary shaft 21.

The rotary shaft 21 includes, for example, a radially outer circumferential surface 21c, a male threaded portion 21e, and a flange portion 21f. For example, the hub member 23 is attached to a central part in the axial direction X on the radially outer circumferential surface 21c. The male threaded portion 21e is located, for example, on the axially one side (+X) of the radially outer circumferential surface 21c with respect to an area to which the hub member 23 is attached. The flange portion 21f is located, for example, on the axially other side (-X) of the radially outer circumferential surface 21c with respect to the area to which the hub member 23 is attached.

The flange portion 21f protrudes, for example, outward in the radial direction from the radially outer circumferential surface 21c. The shape of the flange portion 21f is not particularly limited and is, for example, a disk shape centered on the center axis J. The male threaded portion 21e is formed on the radially outer circumferential surface 21c of the rotary shaft 21. For example, a nut member 28 is fastening the male threaded portion 21e. The hub member 23 attached to the radially outer circumferential surface 21c is interposed, for example, between the flange portion 21f and the nut member 28. Accordingly, the hub member 23 is fixed in the axial direction X with respect to the rotary shaft 21.

For example, a first recessed portion 21p is positioned on the radially outer circumferential surface 21c of the rotary shaft 21. For example, one or more screw holes 21q are positioned in the bottom surface facing outward in the radial direction of the first recessed portion 21p. A first key member 21K is inserted into the first recessed portion 21p. The shape of the first key member 21K is not particularly limited and is, for example, a prismatic shape extending in the axial direction X. The first key member 21K is fixed to the bottom surface of the first recessed portion 21p, for example, with a first key fixing bolt 21j fastening the screw hole 21q. Accordingly, the first key member 21K is attached to the radially outer circumferential surface 21c of the rotary shaft 21. The first key member 21K protrudes outward in the radial direction with respect to the radially outer circumferential surface 21c in a state in which it is attached to the radially outer circumferential surface 21c of the rotary shaft 21.

The hub member 23 is located on a radially outer side of the rotary shaft 21. The hub member 23 has, for example, a cylindrical shape with a sufficient thickness in the radial direction. The hub member 23 is fixed to the radially outer circumferential surface 21c of the rotary shaft 21.

The hub member 23 is formed of, for example, a composite material. That is, the hub member 23 is formed by unifying a plurality of materials as one body. The hub member 23 may be, for example, a composite material of a metal and a ceramic. The hub member 23 may be formed of, for example, a material of which a strength has been enhanced by reinforcing a plastic with a reinforcing member. Examples of the reinforcing member include a fiber-shaped material or a particle-shaped material.

In the present embodiment, the hub member 23 is, for example, a fiber-reinforced plastic. In this case, the hub member 23 is increased in strength and rigidity by reinforcing the plastic with a fiber material. Glass fiber and carbon fiber can be used as the fiber material, and the rigidity and the strength of the hub member 23 can be easily increased using carbon fiber. That is, the hub member 23 is, for example, a carbon-fiber-reinforced plastic.

The hub member 23 includes, for example, a first hub end surface 23a, a second hub end surface 23b, a radially outer circumferential surface 23c, and a radially inner circumferential surface 23d. The first hub end surface 23a faces, for example, the axially one side (+X). The second hub end surface 23b faces, for example, the axially other side (-X). The first hub end surface 23a and the second hub end surface 23b are, for example, flat surfaces. The first hub end surface 23a and the second hub end surface 23b are not necessarily completely flat and allow an error range in design. The radially outer circumferential surface 23c is, for example, a cylindrical surface facing a radially outer side. The radially inner circumferential surface 23d is, for example, a cylindrical surface facing a radially inner side.

As illustrated in FIG. 2, for example, a first key groove 23g extending in the axial direction X is positioned in the radially inner circumferential surface 23d of the hub member 23. The first key member 21K is fitted into the first key groove 23g. That is, the width of the first key groove 23g is almost equal to the width of the first key member 21K or slightly greater than the width of the first key member 21K. Accordingly, the hub member 23 is positioned in the circumferential direction about the rotary shaft 21. Here, the first key member 21K attached to the rotary shaft 21 and the first key groove 23g positioned in the hub member 23 constitute a first key connection member 5A connecting the rotary shaft 21 and the hub member 23. The rotor 20 according to the present embodiment may include the first key connection member 5A.

As illustrated in FIG. 1, for example, a second recessed portion 23p is positioned in the radially outer circumferential surface 23c of the hub member 23. For example, one or more screw holes 23q are positioned in the bottom surface of the second recessed portion 23p facing the radially outer side. A second key member 23K is inserted into the second recessed portion 23p. The shape of the second key member 23K is not particularly limited and is, for example, a prismatic shape extending in the axial direction X. The second key member 23K is fixed to the bottom surface of the second recessed portion 23p, for example, by a second key fixing bolt 23j fastening the screw hole 23q. Accordingly, the second key member 23K is attached to the radially outer circumferential surface 23c of the hub member 23. The second key member 23K protrudes outward in the radial direction with respect to the radially outer circumferential surface 23c in a state in which it is attached to the radially outer circumferential surface 23c of the hub member 23. Although not illustrated in FIG. 1, it is preferable that the screw hole 23q positioned in the hub member 23 be formed by embedding a nut member in the hub member 23.

For example, a plurality of first through-holes (through-holes) 23h penetrating the hub member 23 in the axial direction X is positioned in the hub member 23. The plurality of through-holes are arranged, for example, at equal intervals in the circumferential direction. An end on the axially one side (+X) of each first through-hole 23h is open to the first hub end surface 23a. An end on the axially other side (-X) of each first through-hole 23h is open to the second hub end surface 23b. Vent holes penetrating the hub member 23 in the axial direction in addition to the first through-holes 23h may be positioned in the hub member 23. The first through-holes 23h and the vent holes may be the same.

The rotor core 27 is formed of a magnetic material. The rotor core 27 is not particularly limited and is, for example, a stacked steel plate in which a plurality of electromagnetic steel sheets are stacked in the axial direction X. In this case, the plurality of electromagnetic steel sheets may be bonded, for example, by a bonding means such as welding, adhesion, or caulking. The rotor core 27 has, for example, a cylindrical shape. The rotor core 27 is located on the radially outer side of the hub member 23. The rotor core 27 surrounds the hub member 23 from the radially outer side.

The rotor core 27 includes, for example, a first core end surface 27a, a second core end surface 27b, a radially outer circumferential surface 27c, and a radially inner circumferential surface 27d. The first core end surface 27a faces, for example, the axially one side (+X). The second core end surface 27b faces, for example, the axially other side (-X). The first core end surface 27a and the second core end surface 27b are, for example, flat surfaces. The radially outer circumferential surface 27c is, for example, a cylindrical surface facing the radially outer side. The radially inner circumferential surface 27d is, for example, a cylindrical surface facing the radially inner side.

Here, a size L2 in the axial direction X of the rotor core 27 is referred to as a core size L2. The core size L2 is a size in the axial direction X between the first core end surface 27a and the second core end surface 27b. A size L1 in the axial direction X of the hub member 23 is referred to as a hub size L1. The hub size L1 is a size in the axial direction X between the first hub end surface 23a and the second hub end surface 23b.

In the rotor 20 according to the present embodiment, it is preferable that the hub size L1 be larger than the core size L2 (L1>L2). A difference d (=L1-L2) between the hub size L1 and the core size L2 is much smaller than the hub size L1 and the core size L2. In the rotor 20 according to the present embodiment, the second core end surface 27b is disposed to be flush with the second hub end surface 23b. On the other hand, the first core end surface 27a is located on the axially other side (-X) by the difference d from the first hub end surface 23a.

As illustrated in FIG. 2, for example, a second key groove 27g extending in the axial direction X is positioned in the radially inner circumferential surface 27d of the rotor core 27. The second key member 23K is fitted into the second key groove 27g. That is, the width of the second key groove 27g is, for example, almost equal to the width of the second key member 23K or slightly greater than the width of the second key member 23K. Accordingly, the rotor core 27 is positioned in the circumferential direction with respect to the hub member 23. Here, the second key member 23K attached to the hub member 23 and the second key groove 27g positioned in the rotor core 27 constitute a second key connection member 5B connecting the hub member 23 and the rotor core 27. That is, the rotor 20 according to the present embodiment includes the second key connection member 5B. The shape of the first key member 21K and the shape of the second key member 23K may be the same or different. Similarly, the shape of the first key groove 23g and the shape of the second key groove 27g may be the same or different.

The magnet unit 25 is disposed, for example, on the radially outer circumferential surface 27c of the rotor core 27. In the rotor 20 according to the present embodiment, the magnet unit 25 is a surface magnet type in which the magnet unit 25 magnetically directly faces a stator 30, but the configuration of the rotor 20 is not limited to this embodiment and may be, for example, an embedded magnet type. The magnet unit 25 is covered, for example, by a cylindrical cover 26. In this case, the cover 26 is formed of, for example, a material which is less likely to affect a magnetic force of the magnet unit 25. Examples of the material include a fiber-reinforced plastic and a titanium ring.

The magnet unit 25, for example, the rotor 20, includes a plurality of magnets 25s and 25n which are arranged on the radially outer circumferential surface 27c of the rotor core 27 and in which magnetization directions alternate in the circumferential direction. For example, the magnets 25s and 25n are bonded and fixed to the radially outer circumferential surface 27c of the rotor core 27.

The first fixing member 50 and the second fixing member 60 are positioned to fix the hub member 23 and the rotor core 27 in the axial direction X. The first fixing member 50 is located, for example, on the axially one side (+X) of the hub member 23 and the rotor core 27. The second fixing member 60 is located, for example, on the axially other side (-X) of the hub member 23 and the rotor core 27.

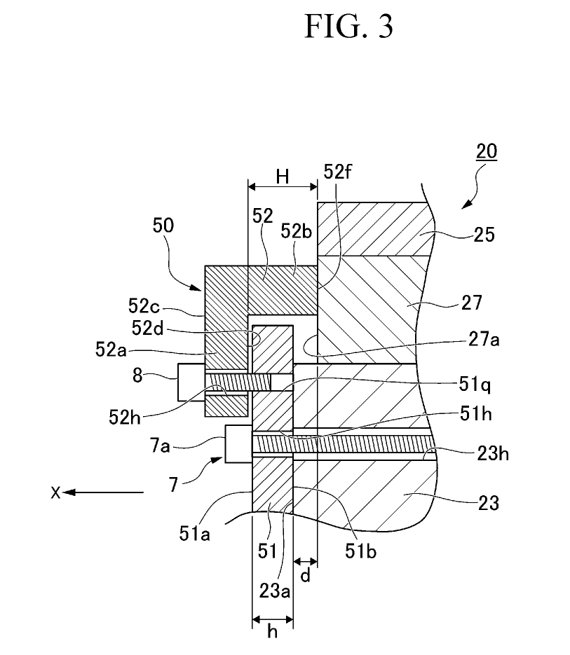

FIG. 3 is a partial sectional view of the vicinity of the first fixing member 50 of the rotor 20 according to the present embodiment.

As illustrated in FIG. 3, the first fixing member 50 includes, for example, a base portion 51, a pressing portion 52, and a fixing bolt 8.

The base portion 51 has, for example, a plate shape with the axial direction X as a thickness direction. The base portion 51 has, for example, a ring shape centered on the center axis J. The base portion 51 includes, for example, a first base surface 51a and a second base surface 51b. The first base surface 51a faces, for example, the axially one side (+X). The second base surface 51b faces, for example, the axially other side (-X). The first base surface 51a and the second base surface 51b are, for example, flat surfaces. The first base surface 51a and the second base surface 51b are not necessarily completely flat and allow an error range in design.

The second base surface 51b is in contact with the first hub end surface 23a of the hub member 23. That is, the first fixing member 50 is in contact with the hub member 23, for example, at the base portion 51. For example, the second base surface 51b faces the first core end surface 27a of the rotor core 27 with a gap therebetween in the axial direction X. In the present embodiment, the first core end surface 27a is located on the axially other side (-X) by the difference d with respect to the first hub end surface 23a.

For example, an inner diameter of the base portion 51 is larger than an outer diameter of the rotary shaft 21 and smaller than an outer diameter of the hub member 23. For example, an outer diameter of the base portion 51 is larger than the outer diameter of the hub member 23 and an inner diameter of the rotor core 27 and smaller than an outer diameter of the rotor core 27. The outer diameter of the base portion 51 may be smaller than the outer diameter of the hub member 23 and the inner diameter of the rotor core 27.

As illustrated in FIG. 3, for example, a plurality of screw holes 51q and a plurality of second through-holes 51h are positioned in the base portion 51. The plurality of second through-holes 51h penetrate the base portion 51 in the axial direction X. Accordingly, the plurality of second through-holes 51h are open to the first base surface 51a and the second base surface 51b.

The plurality of screw holes 51q are arranged in the circumferential direction. The plurality of second through-holes 51h are arranged in the circumferential direction. For example, fixing bolts 8 are screwed into the screw holes 51q.

The second through-holes 51h are located, for example, on the radially inner side with respect to the screw holes 51q. The second through-holes 51h overlap the first through-holes 23h of the hub member 23 when seen in the axial direction X.

The pressing portion 52 includes, for example, a fixing plate portion 52a and a protruding portion 52b. The fixing plate portion 52a has, for example, a plate shape with the axial direction X as a thickness direction. The fixing plate portion 52a has, for example, a ring shape centered on the center axis J. The protruding portion 52b protrudes from an end on the radially outer side of the fixing plate portion 52a to the axially other side (-X).

The fixing plate portion 52a is located on the axially one side (+X) of the base portion 51. The inner diameter of the fixing plate portion 52a is larger than the inner diameter of the base portion 51 and smaller than the outer diameter of the base portion 51. Accordingly, the fixing plate portion 52a overlaps the base portion 51 when seen in the axial direction X.

The fixing plate portion 52a includes, for example, a facing surface 52d and an opposite surface 52c. The facing surface 52d faces, for example, the axially other side (-X). The opposite surface 52c faces, for example, the axially one side (+X).

For example, a fourth through-hole 52h is positioned in the fixing plate portion 52a. For example, the fourth through-hole 52h penetrates the fixing plate portion 52a in the axial direction X. The fourth through-hole 52h overlaps the screw hole 51q of the base portion 51 when seen in the axial direction X.

The protruding portion 52b has, for example, a cylindrical shape centered on the center axis J. An inner diameter of the protruding portion 52b is larger than the outer diameter of the base portion 51. The protruding portion 52b is located on the radially outer side of the base portion 51. The protruding portion 52b surrounds the base portion 51 from the radially outer side.

The protruding portion 52b includes a pressing surface 52f. The pressing surface 52f according to the present embodiment is a flat surface facing the axially other side (-X). The pressing surface 52f is not necessarily completely flat and allows an error range in design. For example, the pressing surface 52f extends in a ring shape in the circumferential direction about the center axis J. The pressing surface 52f is in contact with the first core end surface 27a of the rotor core 27.

A protruding size H of the protruding portion 52b is, for example, equal to or larger than a sum of the thickness h of the base portion 51 and the difference d (H≥h+d). The facing surface 52d of the pressing portion 52 and the first base surface 51a of the base portion 51 face each other with a gap in the axial direction X.

The protruding size H of the protruding portion 52b is a distance in the axial direction X between the facing surface 52d and the pressing surface 52f. The thickness h of the base portion 51 is a distance in the axial direction X between the first base surface 51a and the second base surface 51b.

A shaft portion of the fixing bolt 8 passes through the fourth through-hole 52h of the fixing plate portion 52a and is screwed into the screw hole 51q of the base portion 51. A head portion of the fixing bolt 8 is located on the axially one side (+X) of the fixing plate portion 52a and is in contact with the opposite surface 52c of the fixing plate portion 52a. By screwing the fixing bolt 8 into the screw hole 51q, the pressing surface 52f is pressed against the first core end surface 27a of the rotor core 27. Here, the base portion 51 and the pressing portion 52 are formed as separate components, but the base portion 51 and the pressing portion 52 may be formed as a unified component. By employing a structure in which the base portion 51 and the pressing portion 52 are formed as separate components and are fastened to each other, it is possible to improve a degree of allowance of a dimensional error of each component and to improve productivity.

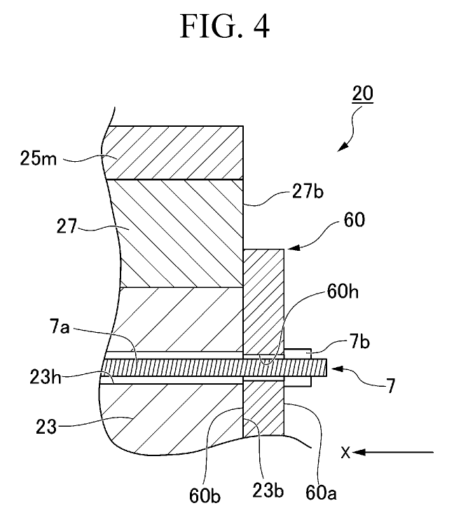

FIG. 4 is a partial sectional view of the rotor 20 including the second fixing member 60.

The second fixing member 60 according to the present embodiment has, for example, almost the same shape as the base portion 51 of the first fixing member 50. The second fixing member 60 has, for example, a plate shape with the axial direction X as a thickness direction. The second fixing member 60 has, for example, a ring shape centered on the center axis J.

The second fixing member 60 includes, for example, a first fixing member surface 60a and a second fixing member surface 60b. The first fixing member surface 60a faces, for example, the axially other side (-X). The second fixing member surface 60b faces, for example, the axially one side (+X). The first fixing member surface 60a and the second fixing member surface 60b are, for example, flat surfaces. The first fixing member surface 60a and the second fixing member surface 60b are not necessarily completely flat and allow an error range in design.

For example, the second fixing member surface 60b is in contact with the second hub end surface 23b of the hub member 23. For example, the second fixing member surface 60b is also in contact with the second core end surface 27b of the rotor core 27. That is, for example, the second fixing member 60 is in contact with the hub member 23 and the rotor core 27. Accordingly, the second hub end surface 23b and the second core end surface 27b are disposed, for example, to be flush with each other.

For example, an inner diameter of the second fixing member 60 is larger than the outer diameter of the rotary shaft 21 and smaller than the outer diameter of the hub member 23. For example, an outer diameter of the second fixing member 60 is larger than the outer diameter of the hub member 23 and the inner diameter of the rotor core 27 and smaller than the outer diameter of the rotor core 27. The outer diameter of the second fixing member 60 may be larger than the outer diameter of the rotor core 27.

For example, a plurality of third through-holes 60h are positioned in the second fixing member 60. The plurality of third through-holes 60h penetrate the second fixing member 60 in the axial direction X. The plurality of third through-holes 60h are open to the first fixing member surface 60a and the second fixing member surface 60b. The third through-holes 60h overlap the first through-holes 23h of the hub member 23 and the second through-holes 51h of the base portion 51 when seen in the axial direction X.

As illustrated in FIG. 1, the connection member 7 includes, for example a connection bolt 7a and a connection nut 7b. In the rotor 20 according to the present embodiment, the base portion 51 of the first fixing member 50 and the second fixing member 60 are disposed on both sides of the hub member 23 in the axial direction X. The shaft portion of the connection bolt 7a passes through, for example, the second through-hole 51h of the base portion 51, the first through-hole 23h of the hub member 23, and the third through-hole 60h of the second fixing member 60.

For example, the head portion of the connection bolt 7a is disposed on the axially one side (+X) of the base portion 51 and is in contact with the first base surface 51a. For example, the connection nut 7b is disposed on the axially other side (-X) of the second fixing member 60 and is in contact with the first fixing member surface 60a. By screwing the connection bolt 7a to the connection nut 7b, the second base surface 51b of the base portion 51 is pressed against the first hub end surface 23a, and the second fixing member surface 60b of the second fixing member 60 is pressed against the second hub end surface 23b. Accordingly, the base portion 51 and the second fixing member 60 are fixed with respect to the hub member 23. That is, the first fixing member 50 and the second fixing member 60 are fixed to the hub member 23 by the connection member 7.

The connection member 7 according to the present embodiment is an example, and the configuration of the connection member 7 is not limited to the present embodiment. The connection member 7 may have any configuration as long as it applies a force in a direction in which the first fixing member 50 and the second fixing member 60 are connected and become closer to each other.

A positioning structure for positioning the base portion 51 with respect to the first hub end surface 23a may be positioned in the first hub end surface 23a and the base portion 51. Similarly, a positioning structure for positioning the second fixing member 60 with respect to the second hub end surface 23b may be positioned in the second hub end surface 23b and the second fixing member 60. For example, a positioning pin and a positioning hole into which the positioning pin is inserted can be exemplified as the positioning structure.

In the rotor 20 according to the present embodiment, when the fixing bolt 8 of the first fixing member 50 illustrated in FIG. 3 is screwed, the pressing portion 52 presses the rotor core 27 to the axially other side (-X). As illustrated in FIG. 4, the rotor core 27 is supported by the second fixing member 60 from the axially other side (-X). Accordingly, the rotor core 27 is interposed between the pressing portion 52 and the second fixing member 60 and fixed in the axial direction X. That is, the first fixing member 50 and the second fixing member 60 interposed the rotor core 27 therebetween and fix the rotor core 27 in the axial direction X.

The configuration and operational advantages of the rotor 20 according to the present embodiment will be summarized below.

The rotor 20 according to the present embodiment is able to rotate about a center axis J. The rotor 20 includes the rotary shaft 21, the hub member 23, the rotor core 27, the magnets 25n and 25s, the first fixing member 50, and the second fixing member 60. The rotary shaft 21 extends in the axial direction X of the center axis J. The hub member 23 is positioned on the radially outer side of the rotary shaft 21. The rotor core 27 is positioned on the radially outer side of the hub member 23. The magnets 25n and 25s are positioned on the radially outer circumferential surface 27c of the rotor core 27. The first fixing member 50 is positioned on the axially one side (+X) of the hub member 23 and the rotor core 27. The first fixing member 50 is in contact with the hub member 23. The second fixing member 60 is positioned on the axially other side (-X) of the hub member 23 and the rotor core 27. The second fixing member 60 is in contact with the hub member 23. The hub member 23 is formed of a composite material. The first fixing member 50 and the second fixing member 60 sandwich the rotor core 27 from both sides in the axial direction X.

With this configuration, the hub member 23 disposed between the rotor core 27 and the rotary shaft 21 in the rotor 20 is formed of a composite material. Accordingly, it is possible to secure sufficient strength and rigidity of the hub member 23 and to achieve a decrease in weight of the rotor 20.

In general, in the rotor 20 which rotates fast, it is necessary to strongly fix the rotor core 27 to the hub member 23. When the rotor core 27 and the hub member 23 rattle in the axial direction X, there is concern about occurrence of unbalance in the axial direction X and occurrence of vibration hindering stable rotation of the rotor. When the hub member 23 formed of a composite material and the rotor core 27 are fixed by bonding, tensile stress in a tearing direction may be applied to the composite material due to a difference in thermal expansion coefficient between the rotor core and the hub member, which may cause damage of the hub member.

On the other hand, with the aforementioned configuration, the first fixing member 50 and the second fixing member 60 are in contact with the hub member 23 from both sides of the hub member23. The first fixing member 50 and the second fixing member 60 sandwich the rotor core 27 from both sides in the axial direction X. Accordingly, the rotor core 27 can be fixed in the axial direction X with respect to the hub member 23. With this configuration, since the rotor core 27 is interposed and supported between the first fixing member 50 and the second fixing member 60, the rotor core 27 can be fixed to the hub member 23 without forming a screw hole in the rotor core 27. Accordingly, it is possible to curb deterioration of magnetic characteristics of the rotor core 27 due to machining of the screw hole. With this configuration, since an adhesive is not used to fix the rotor core 27 and the hub member 23, it is possible to curb damage of the hub member 23 even when thermal stress is applied to the hub member 23. That is, with this configuration, it is possible to enhance reliability of the fixing member for the hub member 23 and the rotor core 27.

In the rotor 20 according to the present embodiment, the first fixing member 50 includes the base portion 51 and the pressing portion 52. The base portion 51 is in contact with the hub member 23. The pressing portion 52 is fastening the base portion 51 in the axial direction X. The pressing portion 52 is in contact with the first core end surface 27a of the rotor core 27 in the axial direction X.

In general, a member formed of a composite material has difficulty in size management. That is, the axial size of the hub member 23 is less likely to be stabilized. With the aforementioned configuration, by screwing the pressing portion 52 to the base portion 51 in the axial direction X, it is possible to absorb a size error in the axial direction X of the hub member 23 and to press the pressing portion 52 against the first core end surface 27a of the rotor core 27. Accordingly, it is possible to press the rotor core 27 against the second fixing member 60 using the first fixing member 50 and to sandwich the rotor core 27 between the first fixing member 50 and the second fixing member 60.

In the rotor 20 according to the present embodiment, the size in the axial direction X of the hub member 23 (the hub size L1) is larger than the size in the axial direction X of the rotor core 27 (the core size L2).

With this configuration, it is possible to dispose the rotor core 27 between the base portion 51 and the second fixing member 60 and to press the rotor core 27 against the second fixing member 60 using the pressing portion 52. Accordingly, even when the size of the hub member 23 relative to the rotor core 27 is not stable, it is possible to easily press the rotor core 27 against the second fixing member 60 using the first fixing member 50 and to easily fix the rotor core 27.

The rotor 20 according to the present embodiment includes the connection member 7. The first through-hole 23h penetrating the hub member 23 in the axial direction X is positioned in the hub member 23. The connection member 7 passes through the first through-hole 23h. The connection member 7 extends in the axial direction X and connects the base portion 51 and the second fixing member 60. The base portion 51 and the second fixing member 60 sandwich the hub member 23 therebetween.

With this configuration, by screwing the connection member 7, the first fixing member 50 and the second fixing member 60 can be made to be closer to each other, and the hub member 23 can be interposed between the first fixing member 50 and the second fixing member 60. Accordingly, it is possible to fix the first fixing member 50 and the second fixing member 60 to the hub member 23. With this configuration, it is possible to fix the first fixing member 50 and the second fixing member 60 to the hub member 23 without forming a screw hole in the hub member 23. Since the hub member 23 is formed of a composite material, there is a likelihood that strength thereof will be decreased due to machining or the hub member will serve as a start point of damage at the time of use, and it may be difficult to directly form a screw hole therein. According to the present embodiment, since it is not necessary to provide a screw hole in the hub member 23, it is possible to enhance a degree of freedom in selecting a material of the hub member 23.

In the rotor 20 according to the present embodiment, it is preferable that the composite material of the hub member 23 be a fiber-reinforced plastic. In this case, it is possible to secure strength and rigidity of the hub member 23 and to achieve a decrease in weight of the rotor 20.

In the rotor 20 according to the present embodiment, it is more preferable that the composite material of the hub member 23 be a carbon-fiber-reinforced plastic. In this case, it is possible to further enhance strength and rigidity of the hub member 23.

In the present embodiment, it is preferable that the rotor 20 include at least one of the first key connection member 5A and the second key connection member 5B. The first key connection member 5A connects the rotary shaft 21 and the hub member 23. The second key connection member 5B connects the hub member 23 and the rotor core 27. The first key connection member 5A includes the first key member 21K and the first key groove 23g. The first key member 21K is attached to the radially outer circumferential surface 21c of the rotary shaft 21. The first key member 21K protrudes outward in the radial direction with respect to the radially outer circumferential surface 21c of the rotary shaft 21. The first key groove 23g is positioned in the radially inner circumferential surface 23d of the hub member 23. The first key groove 23g extends in the axial direction X. The first key member 21K is fitted into the first key groove 23g. The second key connection member 5B includes the second key member 23K and the second key groove 27g. The second key member 23K is attached to the radially outer circumferential surface 23c of the hub member 23. The second key member 23K protrudes outward in the radial direction X with respect to the radially outer circumferential surface 23c of the hub member 23. The second key groove 27g is positioned in the radially inner circumferential surface 27d of the rotor core 27. The second key groove 27g extends in the axial direction X. The second key member 23K is fitted into the second key groove 27g.

With this configuration, when the first key connection member 5A is positioned, it is possible to position the rotary shaft 21 with respect to the hub member 23 in the circumferential direction. With this configuration, when the second key connection member 5B is positioned, it is possible to position the rotor core 27 with respect to the hub member 23 in the circumferential direction. Accordingly, a torque can be transmitted from the rotor core 27 to the rotary shaft 21 via the hub member 23 without rattling. Since an adhesive is not used to position the hub member 23 and the rotary shaft 21 or the rotor core 27 in the circumferential direction, it is possible to curb occurrence of damage due to a difference in thermal expansion coefficient between a composite material and a metallic material even when heat is applied thereto.

In the present embodiment, the rotor 20 includes one first key connection member 5A and one second key connection member 5B, but the number of first key connection members 5A and the number of second key connection members 5B are not limited to the present embodiment. One or both of the first key connection member 5A and the second key connection member 5B may not be positioned, and connection thereof may be performed using a connection method without a key such as shrinkage-fitting, expansion-fitting, or a connection structure with a member other than a key.

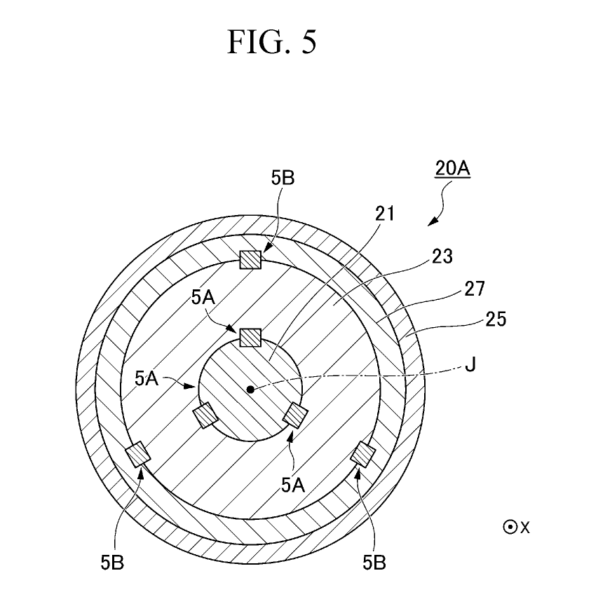

FIG. 5 illustrates a rotor 20A according to a modified example which can be employed by the aforementioned embodiment. As described in the modified example, the rotor 20A may include a plurality of first key connection members 5A or a plurality of second key connection members 5B. When a plurality of first key connection members 5A are positioned, it is possible to curb concentration of stress on one first key connection member 5A and to enhance fixing strength in the circumferential direction of the rotary shaft 21 with respect to the hub member 23. Similarly, when a plurality of second key connection members 5B are positioned, it is possible to curb concentration of stress on one second key connection member 5B and to enhance fixing strength in the circumferential direction of the rotor core 27 with respect to the hub member 23. Accordingly, even when a large rotary torque is applied to the rotor 20A, it is possible to enhance reliability of the fixing member in the circumferential direction of the rotor 20A.

As illustrated in FIG. 2, an electric rotary machine 1 including the rotor according to the present embodiment includes, for example, the rotor 20 and the stator 30. The rotor 20 is able to rotate about the center axis J. The stator 30 has a ring shape centered on the center axis J and surrounds the rotor 20 from the radially outer side.

The electric rotary machine 1 according to the present embodiment is an inner rotor type electric rotary machine in which the rotor 20 is located on the radially inner side of the stator 30. The electric rotary machine 1 may be, for example, an outer rotor type in which the rotor is located on the radially inner side of the stator. Although not illustrated, the electric rotary machine 1 may include, for example, a housing in which the stator 30 and the rotor 20 are accommodated. In this case, the housing rotatably supports the rotor 20, for example, using a bearing.

The stator 30 is located on the radially outer circumferential side of the rotor 20. The stator 30 surrounds the rotor 20 from the radially outer side.

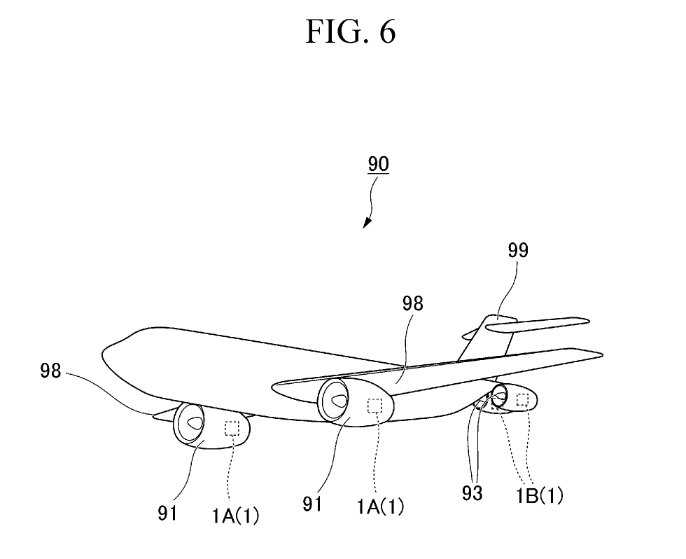

The electric rotary machine including the rotor according to the present embodiment can be mounted in various driving objects such as an automobile, a railway, and an aircraft. FIG. 6 is a schematic diagram of an aircraft 90 which is an example of a driving object in which the electric rotary machine 1 is mounted. The aircraft 90 is a hybrid aircraft that generates a thrust in combination of a jet engine 91 and the electric rotary machine 1. The aircraft 90 includes a pair of jet engines 91 and four electric rotary machines 1. The jet engines 91 are positioned in main wings 98. The jet engines 91 generate a thrust by backwardly exhausting gas.

The four electric rotary machines 1 are classified into two power-generation electric rotary machines 1A and two driving electric rotary machines 1B. The power-generation electric rotary machines 1A are connected to main shafts of the jet engines 91. The power-generation electric rotary machines 1A generate electric power using the jet engines 91. On the other hand, the driving electric rotary machines 1B are disposed below vertical tails 99. The driving electric rotary machines 1B send air backwardly to generate a thrust by rotating a thrust fan 93. The driving electric rotary machines 1B are driven with electric power generated by the power-generation electric rotary machines 1A. When the power-generation electric rotary machines 1A generate surplus electric power, a battery may be charged with this electric power, and the electric power may be used according to necessity.

According to at least one embodiment described above, since the hub member 23 formed of a composite material and the first fixing member 50 and the second fixing member 60 coming into contact with the hub member 23 in the axial direction X and interposing the rotor core 27 from both sides in the axial direction X are positioned, it is possible to achieve a decrease in weight of the rotor 20 and to enhance reliability of the fixing member of the hub member 23 and the rotor core 27.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Electric rotary machine

5A First key connection member

5B Second key connection member

7 Connection member

20, 20A Rotor

21 Rotary shaft

21c, 23c, 27c Radially outer circumferential surface

21K First key member

23 Hub member

23d, 27d Radially inner circumferential surface

23g First key groove

23h First through-hole (through-hole)

23K Second key member

25n, 25s Magnet

27 Rotor core

27g Second key groove

30 Stator

50 First fixing member

51 Base portion

52 Pressing portion

60 Second fixing member

90 Aircraft

93 Thrust fan

J Center axis

L1, L2 Size

X Axial direction

What is claimed is:

1. A rotor rotatable about a center axis, the rotor comprising:
a rotary shaft extending in an axial direction of the center axis;
a hub member positioned on a radially outer side of the rotary shaft;
a rotor core positioned on a radially outer side of the hub member;
a magnet disposed on a radially outer circumferential surface of the rotor core;
a first fixing member positioned on one side in the axial direction of the hub member and the rotor core and being in contact with the hub member; and
a second fixing member positioned on the other side in the axial direction of the hub member and the rotor core and being in contact with the hub member,
wherein the hub member includes a composite material, and
wherein the first fixing member and the second fixing member sandwich the rotor core from both sides in the axial direction.

2. The rotor according to claim 1, wherein the first fixing member comprises a base portion in contact with the hub member and a pressing portion fastening the base portion in the axial direction, and
wherein the pressing portion is in contact with an end surface of the rotor core in the axial direction.

3. The rotor according to claim 2, wherein the hub member is larger in size in the axial direction than the rotor core.

4. The rotor according to claim 2, further comprising:
a connection member,
wherein the hub member has a through-hole penetrating in the axial direction,
wherein the connection member extends in the axial direction via the through-hole and connects the base portion and the second fixing member, and
wherein the base portion and the second fixing member sandwich the hub member.

5. The rotor according to claim 1, wherein the composite material includes a fiber-reinforced plastic.

6. The rotor according to claim 5, wherein the fiber-reinforced plastic is a carbon-fiber-reinforced plastic.

7. The rotor according to claim 1, further comprising:
at least one of a first key connection member connecting the rotary shaft and the hub member and a second key connection member connecting the hub member and the rotor core,
wherein the first key connection member comprises:
a first key member attached to a radially outer circumferential surface of the rotary shaft and protruding outwardly in the radial direction with respect to the radially outer circumferential surface of the rotary shaft; and
a first key groove positioned in a radially inner circumferential surface of the hub member and extending in the axial direction, the first key member being fitted into the first key groove, and
wherein the second key connection member comprises:
a second key member attached to a radially outer circumferential surface of the hub member and protruding outward in the radial direction with respect to the radially outer circumferential surface of the hub member; and
a second key groove positioned in a radially inner circumferential surface of the rotor core and extending in the axial direction, the second key member being fitted into the second key groove.

8. The rotor according to claim 7, wherein the rotor comprises a plurality of key connection members, which comprise the first key connection member.

9. The rotor according to claim 7, wherein the rotor comprises a plurality of key connection members, which comprise the second key connection member.

10. An electric rotary machine comprising:
a rotor rotatable about a center axis; and
a stator positioned on a radially outer circumferential side of the rotor,
wherein the rotor comprises:
a rotary shaft extending in an axial direction of the center axis;
a hub member positioned on a radially outer side of the rotary shaft;
a rotor core positioned on a radially outer side of the hub member;
a magnet disposed on a radially outer circumferential surface of the rotor core;
a first fixing member positioned on one side in the axial direction of the hub member and the rotor core and being in contact with the hub member; and
a second fixing member positioned on the other side in the axial direction of the hub member and the rotor core and being in contact with the hub member,
wherein the hub member includes a composite material, and
wherein the first fixing member and the second fixing member sandwich the rotor core from both sides in the axial direction.

11. An aircraft comprising:
an electric rotary machine comprising: a rotor rotatable about a center axis; and a stator positioned on a radially outer circumferential side of the rotor; and
a thrust fan that is rotatable by the electric rotary machine,
a rotor rotatable about a center axis; and
a stator positioned on a radially outer circumferential side of the rotor,
wherein the rotor comprises:
a rotary shaft extending in an axial direction of the center axis;
a hub member positioned on a radially outer side of the rotary shaft;
a rotor core positioned on a radially outer side of the hub member;
a magnet disposed on a radially outer circumferential surface of the rotor core;
a first fixing member positioned on one side in the axial direction of the hub member and the rotor core and being in contact with the hub member; and
a second fixing member positioned on the other side in the axial direction of the hub member and the rotor core and being in contact with the hub member,
wherein the hub member includes a composite material, and
wherein the first fixing member and the second fixing member sandwich the rotor core from both sides in the axial direction.
